(19) United States
(12) Patent Application Publication
(10) Pub. No.: US 2016/0179319 A1
(43) Pub. Date: Jun. 23, 2016

(54) Parameterized Computed Scrolling for Navigation of Structured Data

(71) Applicant: International Business Machines Corporation, Armonk, NY (US)

(72) Inventors: Nilesh R. Gujarathi, Pune (IN); Amar A. Shah, Pune (IN)

(21) Appl. No.: 14/736,580

(22) Filed: Jun. 11, 2015

Related U.S. Application Data
(63) Continuation of application No. 14/578,612, filed on Dec. 22, 2014.

(51) Int. Cl. G06F 3/0485; G06F 17/30

(52) U.S. Cl. CPC G06F 3/0485; G06F 17/30557; G06F 17/30424

(57) ABSTRACT

Parameters are identified in a structured dataset for user-selection. Selected parameters and designated parameter values are input to establish a parameterized scrolling environment for navigation of the structured dataset.

### BACKGROUND OF THE INVENTION

The present invention relates generally to the field of navigating structured data, and more particularly to scroll-type navigation.

Scrolling allows users to browse through structured data. Various scrolling techniques are practiced in the art. Examples of scrolling techniques include: (i) page-based scrolling; (ii) fixed data scrolling; (iii) variable data scrolling; and (iv) twisties.

Parameterized complexity is a branch of computational complexity theory that focuses on classifying computational problems according to their inherent difficulty with respect to multiple parameters of the input. Basically, parameterized complexity defines a problem system with one or more combinations of parameters that affect and comprise the system.

### SUMMARY

According to an aspect of the present invention, there is a method, computer program product, and/or system that performs the following steps (not necessarily in the following order): (i) providing a user interface for selection of a scroll parameter associated with a structured dataset, (ii) receiving, from the user interface, a scroll parameter, (iii) determining a parameter value, and (iv) generating a structured data display for scrolling navigation based, at least in part, on the scroll parameter and the scroll parameter value.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram view of a machine logic (for example, software) portion of the first embodiment system;

FIG. 4 is a screenshot view generated according to an embodiment of the present invention;

FIG. 5 is a block diagram view of a machine logic (for example, software) portion according to an embodiment of the present invention;

FIG. 6 is a flowchart showing a first embodiment method performed according to an embodiment of the present invention;

FIG. 7 is a flowchart showing a second embodiment method performed according to an embodiment of the present invention; and

FIGS. 8A and 8B are screenshot views showing information that is generated by and/or helpful in understanding embodiments of the present invention.

### DETAILED DESCRIPTION

Parameters are identified in a structured dataset for user-selection. Selected parameters and designated parameter values are input to establish a parameterized scrolling environment for navigation of the structured dataset. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

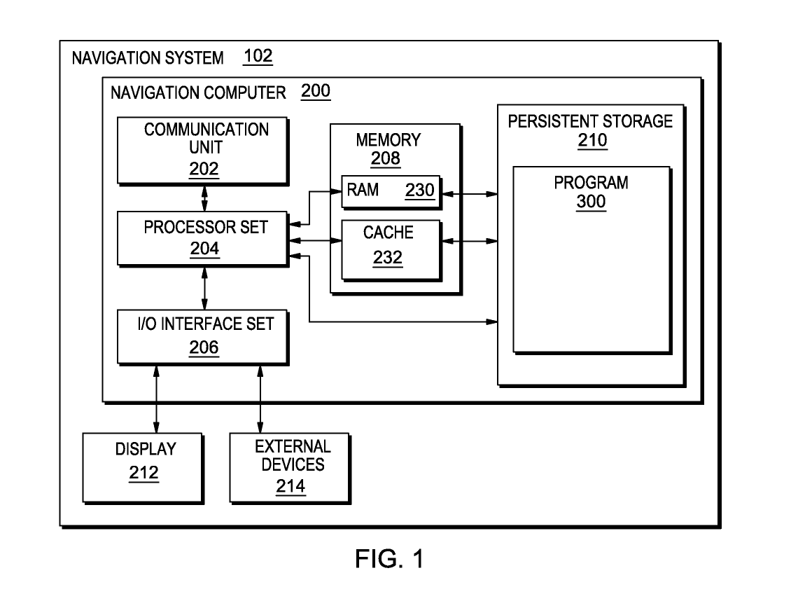

An embodiment of a possible hardware and software environment for software and/or methods according to the present invention will now be described in detail with reference to the Figures. FIG. 1 is a functional block diagram illustrating various portions of navigation computer system 102; navigation computer 200; communication unit 202; processor set 204; input/output (I/O) interface set 206; memory device 208; persistent storage device 210; display device 212; external device set 214; random access memory (RAM) devices 230; cache memory device 232; and program 300.

System 102 is, in many respects, representative of the various computer sub-system(s) in the present invention. Accordingly, several portions of system 102 will now be discussed in the following paragraphs.

System 102 may be, for example, a laptop computer, tablet computer, netbook computer, personal computer (PC), a desktop computer, a personal digital assistant (PDA), or a smart phone. Program 300 is a collection of machine readable instructions and/or data that is used to create, manage and control certain software functions that will be discussed in detail, below.

System 102 is shown as a block diagram with many double arrows. These double arrows (no separate reference numerals) represent a communications fabric, which provides communications between various components of system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for system 102; and/or (ii) devices external to sub-system 102 may be able to provide memory for system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with navigation computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

### II. Example Embodiment

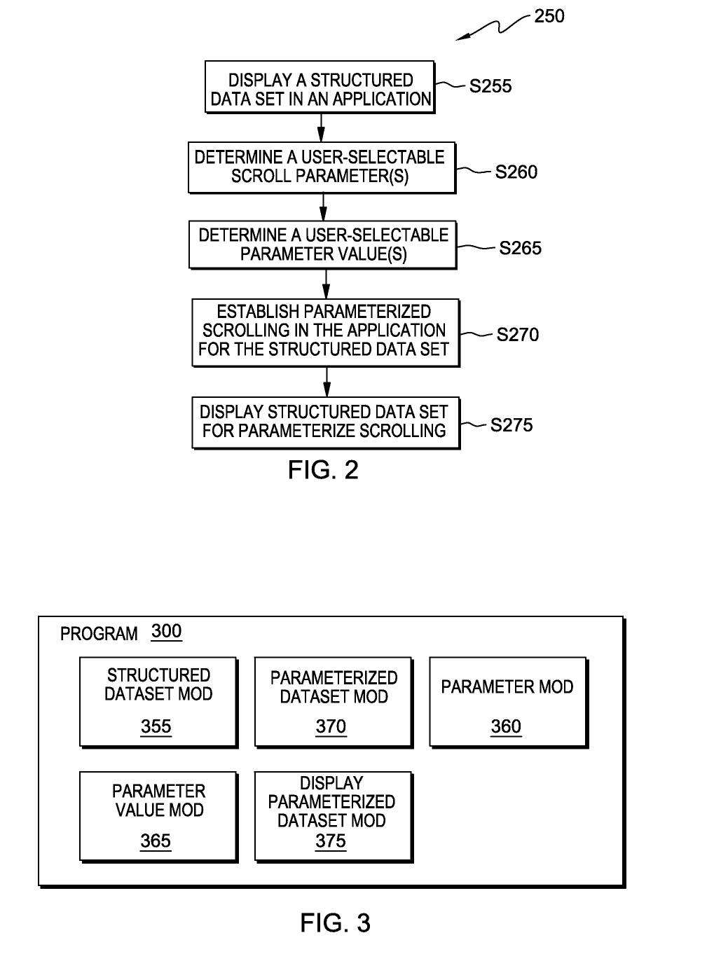

FIG. 2 shows flowchart 250 depicting a method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where structured dataset module (“mod”) 355 displays a structured dataset in an application. In this example, the structured dataset module is pre-programmed to be operated with various specified applications, such as a spreadsheet application and/or an email application. Alternatively, the structured dataset module operates as a plug-in programmed to operate with an application providing the structured dataset. Program 300 may, for example, run in the background, or otherwise provide for parameterized scrolling for a displayed structured dataset.

Processing proceeds to step S260, where parameter module (“mod”) 360 determines a user-selectable scroll parameter(s). In this example, a user selects the user-selectable scroll parameter(s) from a set of pre-determined parameters associated with the displayed structured dataset. In some embodiments, the pre-determination of parameters is made when the structured dataset is created, or during a time when the dataset is being edited. Alternatively, at the time that the structured dataset is displayed, the user is prompted to enter a parameter(s) for scrolling purposes. Alternatively, a user, while viewing the dataset displayed in step S255, activates a field as the parameter(s) for parameterized scrolling.

Processing proceeds to step S265, where parameter value module (“mod”) 365 determines a user-selectable parameter value(s). In this example, the user enters the value of each parameter selected in step 360. Parameter values are parameter-specific. These values, or a value range, may be programmed into the application or specified when the dataset is generated. Alternatively, parameter values are determined based on representative values for the parameter within the displayed dataset. Alternatively, the scroll parameter value is pre-determined according to the determined scroll parameter.

Processing proceeds to step S270, where parameterized dataset module (“mod”) 370 establishes parameterized scrolling in the application for the structured dataset. Establishing the parameterized scrolling in a displayed dataset is discussed in detail below. Essentially, the dataset is processed for scrolling according to the selected parameter and corresponding value. For example, in some embodiments, pointers are generated according to the parameter value to act as scroll-stops for each input scrolling action. Establishing the scrolling feature may include a computing step, where the scroll unit associated with a single scroll action of the user is computed according to the scroll parameter and/or scroll parameter value. A further discussion of computing the scroll unit is provided below.

Processing ends at step S275, where display parameterized dataset module (“mod”) 375 displays a structured dataset for parameterized scrolling. The data in the structured dataset is re-displayed in this step to include the scroll-stops and/or other scroll-control feature(s) known in the art. In some embodiments, the displayed dataset may be presented such that a single scroll unit is presented in one screen view such that each scroll action navigates to a second complete screen view. In other embodiments, a cursor location, for example, the active field in a spreadsheet, advances to a next parameter value for each scroll action.

### III. Further Comments and/or Embodiments

Some embodiments of the present invention recognize the following facts, potential problems, and/or potential areas for improvement with respect to the current state of the art: (i) the complexity of a system of views of structured data objects or document objects having numerous data values is amenable to the application of parameterized complexity; and/or (ii) parameterized computed navigation over a structured dataset provides a smarter navigation for viewing data objects than is conventionally available.

Data objects, as referred to herein, are not limited to the following list, but suggest, for example, one, or multiple: documents, emails, invites, tasks, people contacts, database views, audio, video files, Windows Explorer file, Windows Explorer folder, monitoring events from monitoring agents of systems and applications, trace entries, log entries, messages in message queues, configuration items, configuration assets, and/or tables of contents of documents. (Note: the term(s) “Windows” and/or “Explorer” may be subject to trademark rights in various jurisdictions throughout the world and are used here only in reference to the products or services properly denominated by the marks to the extent that such trademark rights may exist.)

Conventionally, when archiving selected documents in order to reduce a dataset by 100 MB (megabytes) of data storage requirements, users typically choose an oldest document from a display of available documents sorted by a particular date, whether last-modified date, or creation date. From that oldest document, the user then selects increasingly newer documents, according to the sorted date, such that approximately 100 MB of data is selected. Alternatively, the user may open a dialog and input 100 MB as the target storage size, then select an option such as “oldest documents.” Once the data is selected, regardless of the method, archiving is performed on the selected documents.

The following use cases provide the reader with familiar examples where application of some embodiments of the present invention are helpful. For a given structured dataset, a user wants to archive emails received over the last 6 weeks to reduce data storage requirements. Some embodiments of the present invention are directed to a single scroll action that can page up/down by a user-input value of 1.5 weeks. In that way, performing the scroll action four times results in scrolling through six week of data. A user may simply select the data during the scrolling actions to quickly select the last six weeks of new data for archiving.

For another example, a user has to scroll many times to advance through a structured dataset to reach the next desired range of values. Conventionally, the user cannot navigate and/or jump to the next desired value, or element, such as entries with next week from a current view. Further, a user cannot scroll to an entry located after a set of documents requiring 50 MB of storage. Further, in email sorted by “WHO,” a user cannot use conventional tools to advance via parameterized scrolling from the value “Able” to a next value “Baker”.

For yet another example, in a trace or log file, some embodiments of the present invention provide for a user who is navigating through the current day's logs to change the scroll value such that a scrolling action scrolls through the past two day's logs. Some embodiments of the present invention provide for a user who has sorted by the parameter “component name” to scroll directly to the next component logs.

For still another example, in a database view of a table, some embodiments of the present invention provide for a user to scroll through a table having a column, such as “Pay Grade,” sorted, for example, by “Band A,” “Band B,” and “Band C.” In that way, the user examining the view with employees within the pay grade “Band A,” may use a scrolling action to move a cursor location from within ‘Band A” to the start of the “Band B” entries in the same column.

For still yet another example where a user is navigating through structured data, such as monitoring events reported by a system management program, sorted by, for example, severity, date-time, and/or priority, some embodiments of the present invention provide for the user to input the desired parameter and a corresponding value that results in only a single scroll action performed by the user to navigate to a next desired view.

Some embodiments of the present invention are incorporated into a program or application where certain structured data is viewable (e.g. arranged in columns and/or rows). While viewing data within a given application, the user is provided, via some embodiments of the present invention, a customizable scrolling feature such that the user may select an available scroll parameter and set the value associated with each scrolling action to arrive at the required subset of data. Applications where some embodiments of the present invention may be useful include, but are not limited to: personal information managers (e.g. email, calendars, to-do lists, task lists), database managers, message queues, product development life cycle (PDLC) managers, and/or system application monitors.

It should be noted that navigation via scrolling is not limited to conventional mouse wheels, but also includes: touch pad scrolls, scroll bars, sliding bars, scrolling in touch screens by gestures, scrolling in touch screens by non-touch gestures, air gesture scrolls, mouse button scrolls, joysticks, television remote controls, and/or Windows spot scrolling control. (Note: the term(s) “Windows” and/or “spot scrolling” may be subject to trademark rights in various jurisdictions throughout the world and are used here only in reference to the products or services properly denominated by the marks to the extent that such trademark rights may exist.)

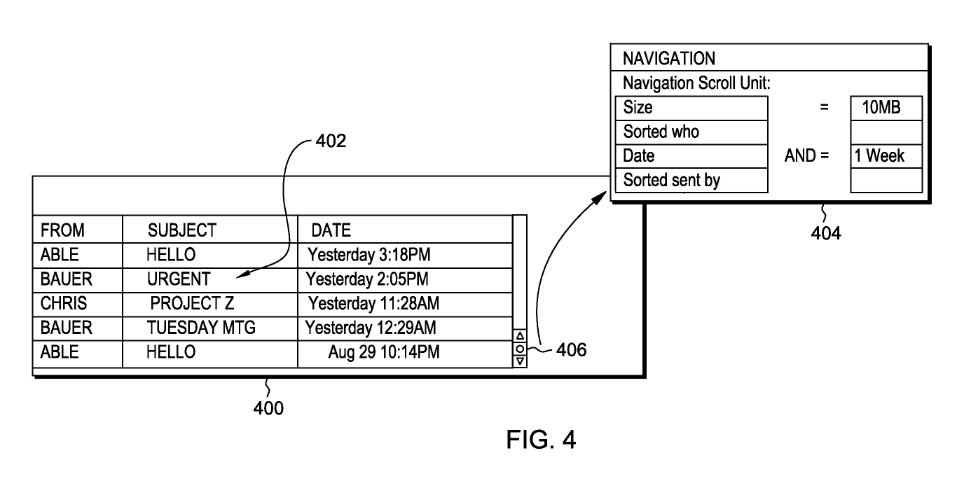

FIG. 4 is screenshot 400 showing parameter selection within structured data 402 via pop up window 404. In this example, button 406 is selected to prompt the pop up of the window for parameter selection and subsequent intelligent navigation. Alternatively, a right click on a mouse makes the pop up window available. Alternatively, a user action, such a scrolling, causes the pop up window to appear in the user interface.

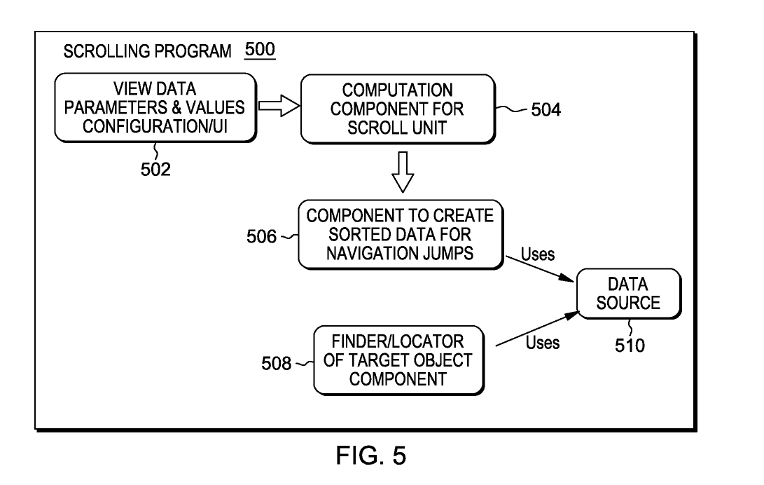

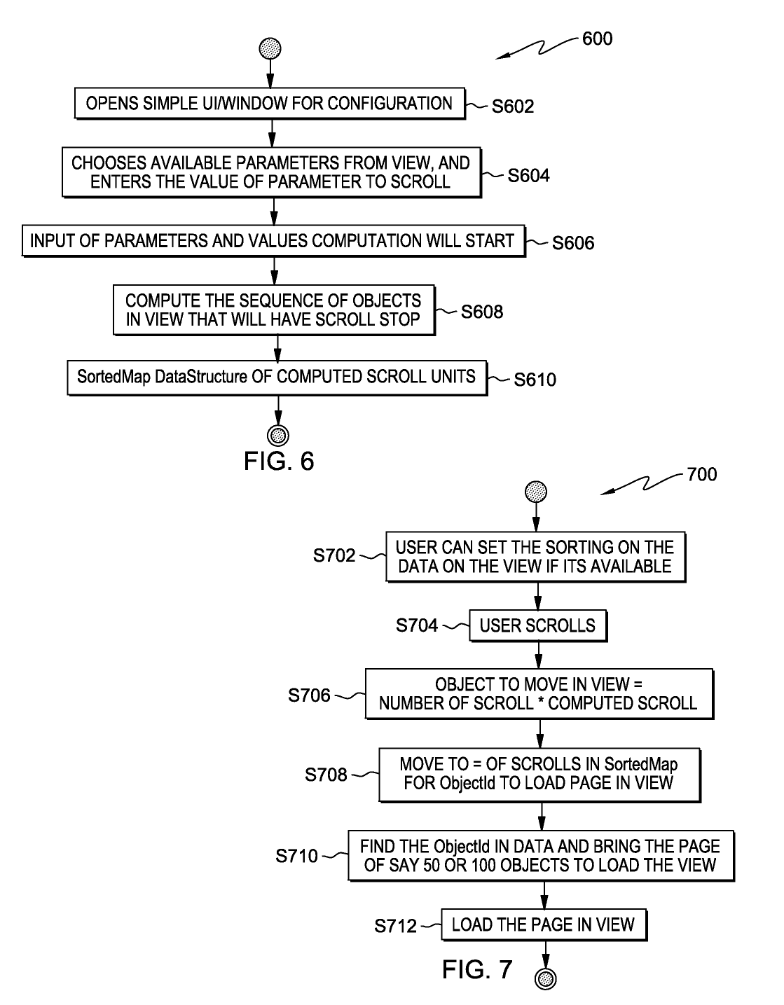

FIG. 5 is a block diagram for scrolling program 500 including: data parameters component 502; computation component 504; sorted data component 506; locator component 508; and data source 510. FIG. 6 is flowchart 600 for computing the parameterized scrolling according to user input.

Processing begins at step S602, were data parameters component 502 presents to a user a simple user interface window for configuring the scroll feature specific to a structured dataset of interest. For example, the user may place a cursor at a first value in a next subset, such as the first document in a “next week” subset when the scroll is preconfigured for one-week scrolling units for the fixed parameter of date/time. It should be noted that oftentimes conventional reviewing of large dataset involves “lazy loading,” where only, for example, 100 data objects out of 100,000 data objects are fetched from a given data source, such as data source 510. In this embodiment, the computed scroll feature, when active, computes the selected parameter and/or value over the full 100,000 data objects.

Processing proceeds to step S604, where computation component 504 receives input from the user that identifies the scrolling parameter and scrolling unit. In this example, the scrolling parameter and unit are both input by the user. Alternatively, default scrolling units are associated with an available scroll parameter such that, when selected, the user does not need to enter a scrolling unit.

Processing proceeds to step S606, where locator component 508 determines the parameter values with respect to the corresponding view(s) of the structured dataset located in data source 510. Continuing with the above example, the pages of structure data associated with the selected parameter value are computed for the dataset of 100,000 data objects.

Processing proceeds to step S608, where sorted data component 506 computes the sequence of data objects being viewed and assigns scroll stops accordingly. In this example, an indicator over the bottom of the scroll bar shows that “smart scroll” is on, when the scroll stops are assigned and ready for use. Further, the user may turn off the smart scrolling feature for default scrolling.

Processing ends at step S610, where sorted data component 506 displays to the user the sorted map data structure having the computed scroll units for navigation by the user. In that way, when the user scrolls by one scroll unit, the sorted data component will retrieve the page view corresponding to one computed unit value. A next scroll advances the display of data to the next computed unit value.

FIG. 7 is flowchart 700 illustrating a method for user input and use of an application according to some embodiments of the present invention. Processing begins at step S702, where data parameters component 502 provides the user with selectable parameters and corresponding units for computed scrolling.

Processing proceeds to step S704, where sorted data component 506 receives scrolling input from the user.

Processing proceeds to step S706, where sorted data component 506 uses the scrolling input received in step S704 to compute the data objects to be displayed. That is, the number of scrolls times the scrolling units.

Processing proceeds to step S708, where locator component 508 moves through the structured dataset according to the computed scrolling input.

Processing proceeds to step S710, where locator component 508 locates the data to be displayed and retrieves the data objects from data source 510 to be displayed.

Processing proceeds to step S712, where sorted data component 506 displays to the user the loaded data objects.

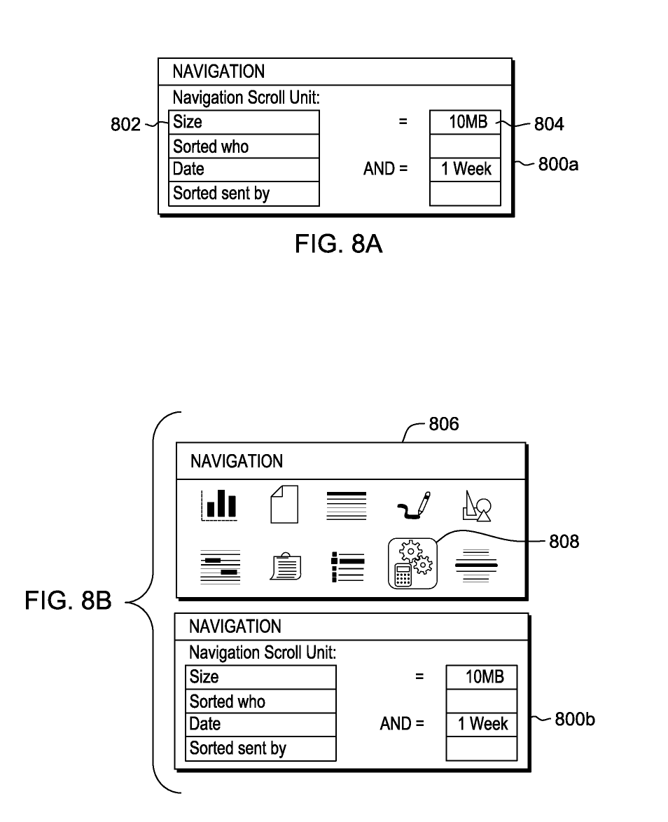

FIGS. 8A and 8B are pop-up menus 800a and 800b, respectively. Each of the pop-up menus display a set of parameters for selection, such as size 802. Also displayed is the unit(s) associated with a specified parameter, for example, the unit “10 MB” 804 corresponding to the parameter “size.” FIG. 8B also shows navigation toolbar 806 associated with pop-up menu 800b. The toolbar provides for additional customization of the computed scrolling inputs, such as entry of manual computing formula 808.

Some embodiments of the present invention may include one, or more, of the following features, characteristics, and/or advantages: (i) an intuitive, effective navigation tool for scrolling through the huge data; (ii) provides the ability to scroll by user-specified parameters, including file size, email sender, component log names, time range, and/or date range; (iii) a single scroll unit is computed according to the selected scroll parameter; (iv) a single scroll action advances a user's view of structured data according to a combination of parameters, such as last-modified date and storage requirement for the set of documents; (v) scrolling action may result in more than simple up/down movement of data on the display screen, but may result in horizontal and/or diagonal scrolling; (vi) operates on parameter selection applied to any structured dataset, not only to datasets prepared with particular tags, or other predetermined metadata associated with the datasets; (vii) user-switchable interface from computed page scrolling to non-computed page scrolling; (viii) navigation method that saves time and effort; (ix) intuitive usability; and/or (x) efficient and faster navigation of data.

### III. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as possibly being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer program product comprising a computer readable storage medium having stored thereon:
first program instructions programmed to provide a user interface for selection of a scroll parameter associated with a structured dataset;
second program instructions programmed to receive, from the user interface, a scroll parameter;
third program instructions programmed to determine a parameter value; and
fourth program instructions programmed to generate a structured data display for scrolling navigation based, at least in part, on the scroll parameter and the scroll parameter value.

2. The computer program product of claim 1, wherein the user interface is pre-programmed in an application providing the structured dataset for display.

3. The computer program product of claim 1, wherein the scroll parameter value is pre-determined according to the scroll parameter.

4. The computer program product of claim 1, further comprising:
fifth program instructions programmed to provide a user-interface for selection of the scroll parameter value.

5. The computer program product of claim 1, further comprising:
fifth program instructions programmed to compute a scroll unit associated with the structured dataset for each scroll action input by a user, based on the scroll parameter and the scroll parameter value.

6. The computer program product of claim 1, wherein the fourth program instructions programmed to generate a structured data display include:
program instructions programmed to sort the structured data according to the scroll parameter.

7. A computer system comprising:
a processor(s) set; and
a computer readable storage medium;
wherein:
the processor set is structured, located, connected, and/or programmed to run program instructions stored on the computer readable storage medium; and
the program instructions include:
first program instructions programmed to provide a user interface for selection of a scroll parameter associated with a structured dataset;
second program instructions programmed to receive, from the user interface, a scroll parameter;
third program instructions programmed to determine a parameter value; and
fourth program instructions programmed to generate a structured data display for scrolling navigation based, at least in part, on the scroll parameter and the scroll parameter value.

8. The computer system of claim 7, wherein the user interface is pre-programmed in an application providing the structured dataset for display.

9. The computer system of claim 7, wherein the scroll parameter value is pre-determined according to the scroll parameter.

10. The computer system of claim 7, further comprising:
fifth program instructions programmed to provide a user-interface for selection of the scroll parameter value.

11. The computer system of claim 7, further comprising:
fifth program instructions programmed to compute a scroll unit associated with the structured dataset for each scroll action input by a user, based on the scroll parameter and the scroll parameter value.

12. The computer system of claim 7, wherein the fourth program instructions programmed to generate a structured data display include:
program instructions programmed to sort the structured data according to the scroll parameter.
